(19) United States
(12) Patent Application Publication
(10) Pub. No.: US 2026/0265926 A1
(43) Pub. Date: Sep. 10, 2026

(54) HYDROGEN-POWERED AUTONOMOUS MOBILE VEHICLE AND OPERATING METHOD OF THE SAME

(71) Applicant: INDUSTRIAL TECHNOLOGY RESEARCH INSTITUTE, HSINCHU (TW)

(72) Inventors: HsinYi LIN, Miaoli County (TW); Ruei-Jhih HONG, Nantou County (TW); Sheng-Yu WU, Changhua County (TW); Lih-Guong JANG, Hsinchu City (TW)

(21) Appl. No.: 19/248,503

(22) Filed: Jun. 25, 2025

(30) Foreign Application Priority Data
Mar. 10, 2025 (TW) 114108808

(51) Int. Cl. C25B 1/044; B60L 50/75

(52) U.S. Cl. CPC C25B 1/044; B60L 50/75

(57) ABSTRACT

A hydrogen-powered autonomous mobile vehicle includes a mixing valve, a hydrogen storage device, a fuel cell, and an electrolyzer. The mixing valve has a first gas intake port coupled to the hydrogen storage device, a second gas intake port, and an outlet port coupled to the fuel cell, and includes a gas intake pipe coupled to the electrolyzer. The fuel cell is configured to perform a first redox reaction based on hydrogen supplied by the hydrogen storage device to generate electric energy and water. The electrolyzer is configured to receive the water and perform a water electrolysis reaction to generate hydrogen. The mixing valve is configured such that the hydrogen supplied by the hydrogen storage device and the hydrogen generated by the water electrolysis reaction converge and are delivered to the fuel cell. The fuel cell is configured to perform a second redox reaction based on the converged hydrogen.

This application claims priority to Taiwan Application Serial Number 114108808, filed Mar. 10, 2025, which is herein incorporated by reference in its entirety.

### TECHNICAL FIELD

The disclosure relates to a hydrogen-powered autonomous mobile vehicle and an operating method of the same.

### BACKGROUND

Autonomous mobile vehicles can meet the transportation requirements of automated equipment and human-machine collaboration. Therefore, autonomous mobile vehicles are gradually used in various industries such as logistics picking. However, such autonomous mobile vehicles are facing a dilemma. For example, common autonomous mobile vehicles rely on batteries as their power sources, but current batteries have limited capacities and need to be charged regularly, which hinders industries from improving sustained operational durations of autonomous mobile vehicles.

### SUMMARY

An aspect of the disclosure is to generate hydrogen and oxygen for a fuel cell to perform a redox reaction by disposing an electrolyzer and performing a water electrolysis reaction by the electrolyzer, in which the hydrogen generated by the water electrolysis reaction and hydrogen supplied by a hydrogen storage device converge by a mixing valve first and then are supplied to the fuel cell. By repeating the redox reaction and the water electrolysis reaction, the power supply duration can be extended, the endurance of hydrogen-powered autonomous mobile vehicles can be improved, and the transportation efficiency for automated warehousing can be improved.

According to an embodiment of the disclosure, a hydrogen-powered autonomous mobile vehicle including a carrier, a mixing valve, a hydrogen storage device, a fuel cell, an energy storage, and an electrolyzer. The mixing valve, the hydrogen storage device, the fuel cell, the energy storage, and the electrolyzer are on the carrier. The mixing valve has a first gas intake port, a second gas intake port, and an outlet port. The first gas intake port and the outlet port are opposite to each other and communicated through a first flow channel. The second gas intake port is communicated with the first flow channel through a second flow channel. The mixing valve further includes a gas intake pipe extending from the second gas intake port through the second flow channel to the first flow channel. The hydrogen storage device is coupled to the first gas intake port of the mixing valve. The fuel cell is configured to perform a first redox reaction based on hydrogen supplied by the hydrogen storage device to generate electric energy and water. The fuel cell is coupled to the outlet port of the mixing valve. The energy storage is configured to receive the electric energy generated by the fuel cell. The electrolyzer is configured to receive the water generated by the fuel cell and perform a water electrolysis reaction to generate hydrogen and oxygen. The electrolyzer is powered by the energy storage. The electrolyzer is coupled to the gas intake pipe of the mixing valve. The mixing valve is configured such that the hydrogen supplied by the hydrogen storage device and the hydrogen generated by the water electrolysis reaction converge and are delivered to the fuel cell. The fuel cell is configured to further perform a second redox reaction based on the converged hydrogen.

In an embodiment, the hydrogen-powered autonomous mobile vehicle further includes a processor. The processor is communicatively connected to the energy storage. The processor is configured to drive the energy storage to supply power to the electrolyzer to perform the water electrolysis reaction when an accumulation of the water received by the electrolyzer from the fuel cell exceeds a predetermined value.

In an embodiment, the hydrogen-powered autonomous mobile vehicle further includes a water flow sensor. The water flow sensor is coupled between the fuel cell and the electrolyzer and communicatively connected to the processor. The water flow sensor is configured to sense a flow rate of the water received by the electrolyzer from the fuel cell and to transmit a sensing signal to the processor.

In an embodiment, an inner diameter of the gas intake pipe is less than an inner diameter of the first flow channel.

In an embodiment, the fuel cell is coupled to the electrolyzer. The fuel cell is configured to receive the oxygen generated by the water electrolysis reaction.

In an embodiment, the hydrogen-powered autonomous mobile vehicle further includes a drive mechanism. The drive mechanism is on the carrier and configured to drive the carrier to move. The drive mechanism is powered by the energy storage.

In an embodiment, the hydrogen-powered autonomous mobile vehicle further includes a gas intake device. The gas intake device is on the carrier and configured to deliver an outside air to the fuel cell. Oxygen for the first redox reaction is provided by the outside air.

In an embodiment, the second flow channel is perpendicular to the first flow channel so that the mixing valve has a T-shaped profile.

In an embodiment, the mixing valve further includes a first connector, a second connector, and a third connector. The first gas intake port is at the first connector. The second gas intake port is at the second connector. The outlet port is at the third connector. The gas intake pipe is coupled to the second connector and has an L-shaped profile. One end of the gas intake pipe extends to the second gas intake port. The other end of the gas intake pipe extends to the outlet port.

According to another embodiment of the disclosure, an operating method of a hydrogen-powered autonomous mobile vehicle, including: performing, by a fuel cell, a first redox reaction based on hydrogen and oxygen to generate electric energy and water; transferring the water generated by the fuel cell to an electrolyzer; performing, by the electrolyzer, a water electrolysis reaction based on the water generated by the fuel cell to generate hydrogen and oxygen, in which the electrolyzer is at least partially powered by the electric energy generated by the fuel cell; after the water electrolysis reaction, allowing the hydrogen generated by the electrolyzer and hydrogen supplied by a hydrogen storage device to converge by a mixing valve, in which the mixing valve has a first gas intake port, a second gas intake port, and an outlet port, in which the first gas intake port and the outlet port are opposite to each other and communicated through a first flow channel, and the second gas intake port is communicated with the first flow channel through a second flow channel, the mixing valve further includes a gas intake pipe that extends from the second gas intake port through the second flow channel to the first flow channel such that a pressure of the hydrogen generated by the electrolyzer and flowing in the gas intake pipe is greater than a pressure of the hydrogen supplied by the hydrogen storage device and flowing in the first flow channel; and further performing, by the fuel cell, a second redox reaction based on the converged hydrogen.

In an embodiment, the first redox reaction is performed based on the hydrogen supplied by the hydrogen storage device and oxygen from an outside air. The outside air is delivered to the fuel cell by a gas intake device.

In an embodiment, the hydrogen generated by the electrolyzer flows through the gas intake pipe of the mixing valve, the hydrogen supplied by the hydrogen storage device flows through the first flow channel of the mixing valve, and an inner diameter of the gas intake pipe is less than an inner diameter of the first flow channel.

In an embodiment, the operating method further includes: delivering the oxygen generated by the electrolyzer to the fuel cell after the water electrolysis reaction such that the fuel cell performs the second redox reaction.

In an embodiment, the operating method further includes storing the electric energy generated by the fuel cell in an energy storage, in which the energy storage is electrically connected to the electrolyzer and configured to supply power to the electrolyzer.

In an embodiment, the operating method further includes supplying, by the energy storage, power to a drive mechanism for a carrier to drive the carrier to move, in which the fuel cell, the electrolyzer, the energy storage, and the drive mechanism are on the carrier.

In an embodiment, the operating method further includes: obtaining, by a sensor, a water level value in the electrolyzer; and when the water level value exceeds a first predetermined value, supplying power to the electrolyzer so that the electrolyzer begins to perform the water electrolysis reaction.

In an embodiment, the sensor is a water flow sensor. The water flow sensor is coupled between the fuel cell and the electrolyzer.

In an embodiment, the obtaining, by the sensor, the water level value in the electrolyzer includes: sensing, by the sensor, a plurality of flow rates of the water transferred by the fuel cell to the electrolyzer at a plurality of time points, and generating a plurality of sensing signals; and receiving, by a processor, the sensing signals, and obtaining the water level value in the electrolyzer based on the plurality of sensing signals, in which the processor is communicatively connected to the sensor.

In an embodiment, the processor is further communicatively connected to an energy storage and is configured to drive the energy storage to supply power to the electrolyzer.

In an embodiment, the operating method further includes stopping supplying power to the electrolyzer when the water level value in the electrolyzer is less than a second predetermined value, in which the second predetermined value is less than the first predetermined value.

Accordingly, in the hydrogen-powered autonomous mobile vehicle and the operating method of the same according to an embodiment of the disclosure, by disposing an electrolyzer, water generated by a redox reaction performed by a fuel cell can be directly collected and subjected to a water electrolysis reaction. Then, hydrogen and oxygen generated by the water electrolysis reaction are directly supplied to the fuel cell for a further redox reaction. To be more specific, hydrogen and oxygen for the fuel cell to perform the redox reaction can be supplied from multiple sources to extend the power supply duration, improve the endurance of the hydrogen-powered autonomous mobile vehicle, and improve the transportation efficiency for automated warehousing.

It is to be understood that both the foregoing general description and the following detailed description are by examples and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a hydrogen-powered autonomous mobile vehicle according to an embodiment of the disclosure;

FIGS. 2 and FIG. 3 are perspective views of a hydrogen-powered autonomous mobile vehicle according to an embodiment of the disclosure;

FIG. 4 is a partial perspective view of a hydrogen-powered autonomous mobile vehicle according to an embodiment of the disclosure; and

FIGS. 5 and FIG. 6 are partial cross-sectional views of a hydrogen-powered autonomous mobile vehicle according to an embodiment of the disclosure.

### DETAILED DESCRIPTION

Reference will now be made in detail to the embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

It should be understood that when an element such as a layer, a film, a region, or a substrate is described as being “on” or “connected to” another element, it can be directly on or connected to the other element, or intermediate elements may also be present. In contrast, when an element is described as being “directly on” or “directly connected to” another element, there are no intermediate elements present. As used herein, “connected” may refer to physical and/or electrical connections. Furthermore, “electrically connected” or “coupled” can indicate the presence of other elements between the two elements.

The terms used herein are merely for the purpose of describing specific embodiments and are not intended to be limiting. As used herein, the singular forms “a,” “an,” and “the” are intended to include the plural forms, including “at least one,” unless the context clearly indicates otherwise. “Or” indicates “and/or.” As used herein, the term “and/or” includes any and all combinations of one or more of the associated listed items. It should also be understood that when used in the specification, the terms “comprising” and/or “including” specify the presence of said features, regions, entities, steps, operations, elements and/or components, but do not exclude the presence or addition of one or more other features, regions, entities, steps, operations, elements, components, and/or combinations thereof.

Furthermore, spatially relative terms, such as “beneath,” “below,” “lower,” “above,” “over,” “upper,” and the like, may be used herein for ease of description to describe one element or feature’s relationship to another element(s) or feature(s) as illustrated in the drawings. It should be understood that the spatially relative terms are intended to encompass different orientations of the device in use or operation in addition to the orientation depicted in the drawings. The device may be otherwise oriented (rotated 90 degrees or at other orientations) and the spatially relative descriptors used herein may likewise be interpreted accordingly.

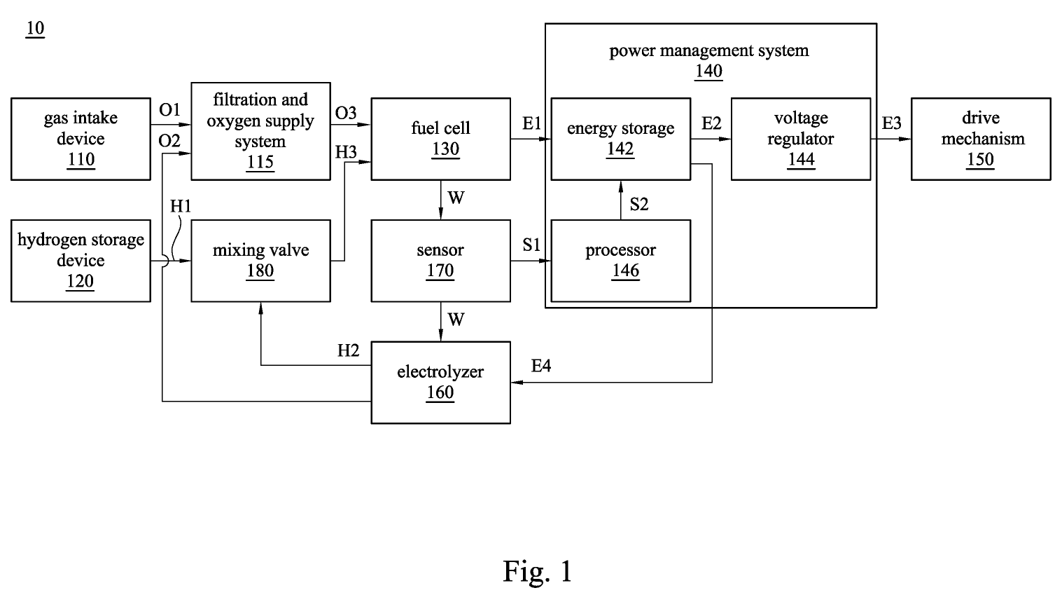

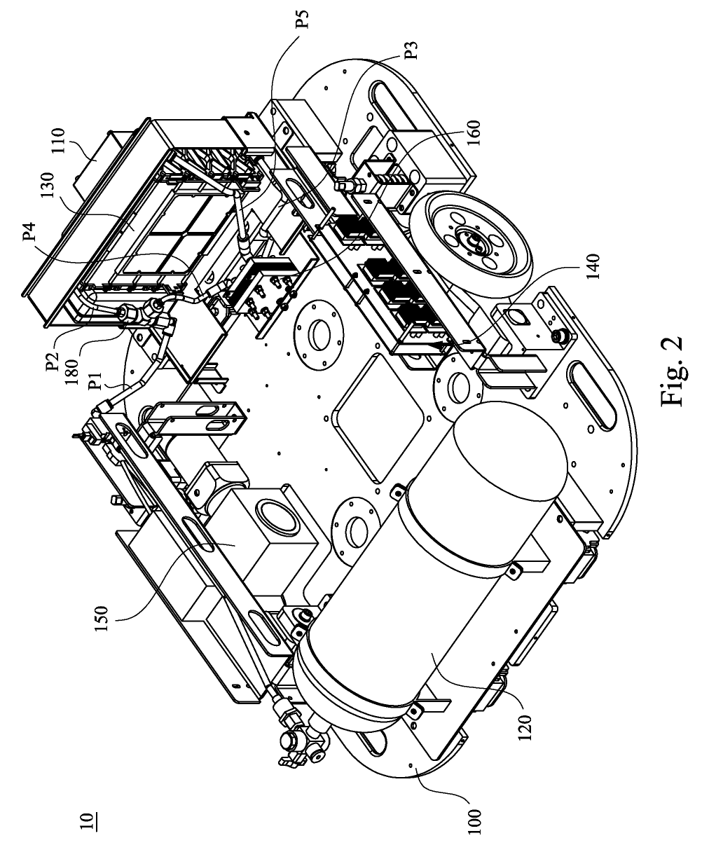

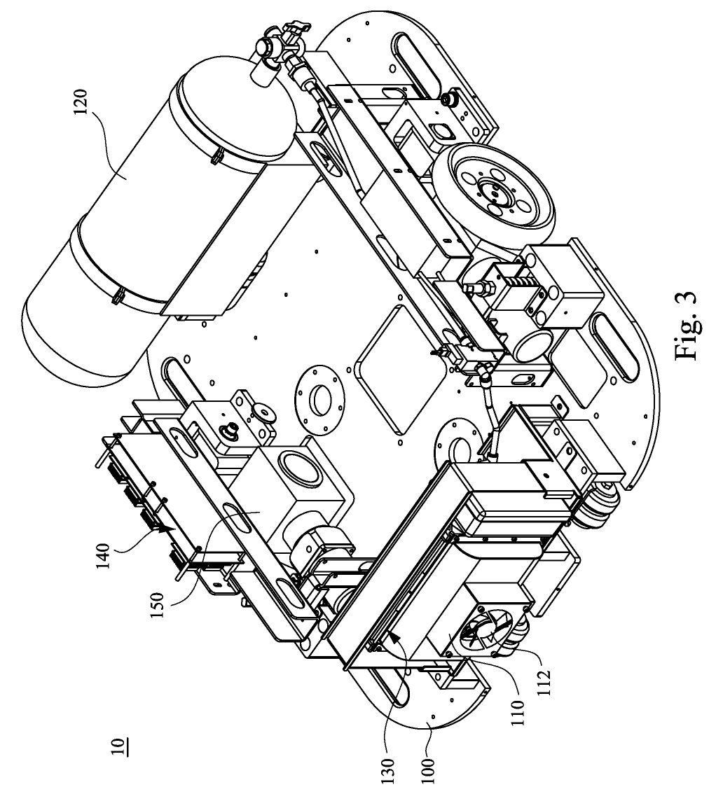

Reference is made to FIGS. 1 to FIG. 3. FIG. 1 is a block diagram of a hydrogen-powered autonomous mobile vehicle 10 according to an embodiment of the disclosure. FIGS. 2 and 3 are perspective views of the hydrogen-powered autonomous mobile vehicle 10 from different view angles.

As shown in FIGS. 1 to FIG. 3, the hydrogen-powered autonomous mobile vehicle 10 includes a carrier 100, a gas intake device 110, a filtration and oxygen supply system 115, a hydrogen storage device 120, a fuel cell 130, a power management system 140, a drive mechanism 150, an electrolyzer 160, a sensor 170, and a mixing valve 180. The gas intake device110, the filtration and oxygen supply system 115, the hydrogen storage device 120, the fuel cell 130, the power management system 140, the drive mechanism 150, the electrolyzer 160, and the mixing valve 180 are on the carrier 100, as shown in FIGS. 2 and FIG. 3.

The gas intake device 110 is coupled to the fuel cell 130 through the filtration and oxygen supply system 115. The gas intake device 110 is configured to deliver an outside air to the fuel cell 130 as an oxygen supply source. As shown in FIGS. 2 and FIG. 3, the gas intake device 110 is disposed at one side of the fuel cell 130 to facilitate the outside air to enter the fuel cell 130. In an embodiment, the gas intake device 110 may include a fan (referring to FIG. 3), and the filtration and oxygen supply system 115 may include a filtration device such as a high efficiency particulate air (HEPA) filter element. In an embodiment, the filtration and oxygen supply system 115 may be disposed in the fuel cell 130. Therefore, the filtration and oxygen supply system 115 is not shown in subsequent figures.

The hydrogen storage device 120 is coupled to the fuel cell 130 through the mixing valve 180. As shown in FIG. 2, the hydrogen storage device 120 is configured to supply hydrogen through a pipeline P1. In an embodiment, the hydrogen storage device 120 may be a high-pressure hydrogen storage cylinder. The hydrogen storage device 120 and the fuel cell 130 can be coupled by, for example, the mixing valve 180. Specifically, the hydrogen storage device 120 is coupled to the mixing valve 180 through the pipeline P1, while the fuel cell 130 is coupled to the mixing valve 180 through a pipeline P2. In an embodiment, a pressure sensor and a solenoid valve are disposed between the hydrogen storage device 120 and the mixing valve 180 (e.g., in the pipeline P1).

The fuel cell 130 is configured to perform a redox reaction based on received hydrogen and oxygen to generate electric energy and water, in which hydrogen and oxygen supply sources of the fuel cell 130 differ at different stages of operation and will be described in detail in subsequent paragraphs. In an embodiment, the fuel cell 130 includes a proton exchange membrane.

The power management system 140 includes an energy storage 142, a voltage regulator 144, and a processor 146. The energy storage 142 is electrically connected to the fuel cell 130 and configured to receive the electric energy generated by the fuel cell 130. The voltage regulator 144 is electrically connected to the energy storage 142 and configured to suppress an inrush current. Electric energy output by the energy storage 142 has a relatively stable voltage after passing through the voltage regulator 144. In this way, when power is supplied to the drive mechanism 150, damage caused by a high voltage or high current surge can be avoided. In other words, the energy storage 142 and the voltage regulator 144 serve as a buffer when the fuel cell 130 supplies power to the drive mechanism 150. In an embodiment, the energy storage 142 is a lithium battery that can be charged and discharged repeatedly, and the voltage regulator 144 is a DC-DC converter. The processor 146 is communicatively connected to the energy storage 142 and is configured to transmit a drive signal that drives the energy storage 142 to supply power to other devices such as the electrolyzer 160. In an embodiment, the processor 146 is a processor of a computing system, e.g., a central processing unit (CPU), a microcontroller unit (MCU), a microprocessor, a programmable logic controller (PLC), or a combination of the aforementioned components. In an embodiment, the power management system 140 further includes a hybrid integrated circuit (HIC).

The drive mechanism 150 is configured to drive the carrier 100 to move. In an embodiment, the drive mechanism 150 includes a motor, a gearbox, and tires, but the disclosure is not limited thereto. As previously mentioned, the drive mechanism 150 is powered by the energy storage 142.

The electrolyzer 160 is coupled to the fuel cell 130. The electrolyzer 160 is configured to receive the water generated by the fuel cell 130 (for example, through a pipeline P3 shown in FIG. 2) and to perform a water electrolysis reaction to generate hydrogen and oxygen. The hydrogen and the oxygen generated by the electrolyzer 160 can be recycled to the fuel cell 130 such that the fuel cell 130 further performs a redox reaction based thereon. In other words, when the electrolyzer 160 is in a power-on state, the hydrogen and the oxygen generated are continuously recycled to the fuel cell 130, together with hydrogen stored by the hydrogen storage device 120 and the outside air drawn by the gas intake device 110, collectively serve as hydrogen and oxygen supply sources for the redox reaction performed by the fuel cell 130.

In an embodiment, the hydrogen generated by the water electrolysis reaction performed by the electrolyzer 160 and the hydrogen supplied by the hydrogen storage device 120 first converge through the mixing valve 180 and then are delivered to the fuel cell 130. In particular, as shown in FIG. 2, the electrolyzer 160 is coupled to the mixing valve 180 through a pipeline P4 and outputs the hydrogen generated by the water electrolysis reaction. In this way, the hydrogen from the pipeline P1 of the hydrogen storage device 120 and the hydrogen from the pipeline P4 of the electrolyzer 160 converge through the mixing valve 180, and then the converged hydrogen is delivered to the fuel cell 130 through the pipeline P2.

In an embodiment, the oxygen generated by the electrolyzer 160 is delivered through, for example, a pipeline P5 to the filtration and oxygen supply system 115 to achieve convergence with oxygen introduced by the gas intake device 110. In an embodiment, the pipeline P4 and the pipeline P5 are separately provided with a check valve to prevent the backflow of the hydrogen and the oxygen. In addition, the electrolyzer 160 is further electrically connected to the energy storage 142, and is powered by the energy storage 142. In an embodiment, the electrolyzer 160 includes a proton exchange membrane.

In order to ensure the stability and efficiency of an electrolysis process, a certain amount of water is required in the electrolyzer 160. Therefore, the sensor 170 is disposed to be coupled between the fuel cell 130 and the electrolyzer 160 and to be communicatively connected to the processor 146. The sensor 170 is configured to directly or indirectly obtain a water level value in the electrolyzer 160. For example, the sensor 170 may be a water flow sensor, and is configured to sense a flow rate of the water received by the electrolyzer 160 from the fuel cell 130 and to transmit a sensing signal corresponding to the flow rate to the processor 146. At the same time, the processor 146 is configured to sum up flow rates of the water sensed by the sensor 170 at a plurality of time points to obtain the water level value in the electrolyzer 160. Also, the processor 146 is configured to transmit a drive signal to the energy storage 142 to drive the energy storage 142 to supply power to the electrolyzer 160 when the water level value in the electrolyzer 160 exceeds a first predetermined value. Thereby, the electrolyzer 160 begins to perform the water electrolysis reaction.

An operating method of the hydrogen-powered autonomous mobile vehicle 10 is described below with reference to FIGS. 1 to FIG. 3.

First of all, an operation of the hydrogen-powered autonomous mobile vehicle 10 when the fuel cell 130 performs a redox reaction based on hydrogen from the hydrogen storage device 120 and oxygen from an outside air is illustrated. This is called a first stage. At this stage, the redox reaction is referred to as a "first redox reaction".

In the first stage, the gas intake device 110 draws the outside air via, for example, a fan 112. The outside air, after passing through the filtration and oxygen supply system 115 to filter out particulates and impurities, is delivered to the fuel cell 130. As shown in FIG. 1, the outside air drawn by the gas intake device 110 includes oxygen O1. The oxygen O1 passes through the filtration and oxygen supply system 115 and forms oxygen O3. Since the outside air is taken as the oxygen supply source in the first stage, the oxygen O3 is substantially composed of the oxygen O1.

At the same time, the hydrogen storage device 120 supplies hydrogen H1 through the pipeline P1. The hydrogen H1 passes through the mixing valve 180 and forms hydrogen H3. The hydrogen H3 is delivered to the fuel cell 130 through the pipeline P2. Since the hydrogen storage device 120 serves as the hydrogen supply source in the first stage, the hydrogen H3 is substantially composed of the hydrogen H1.

Next, the fuel cell 130 performs the first redox reaction to generate electric energy E1 and water W.

As shown in FIG. 1, the energy storage 142 receives the electric energy E1, and then outputs the electric energy E1 as electric energy E2 to the voltage regulator 144 in which the electric energy E2 is then converted into electric energy E3. The electric energy E3 is then transmitted to the drive mechanism 150 as a power supply to drive the carrier 100 to move. It should be noted that prior to the start of the first stage (e.g., at the beginning of the operation of the hydrogen-powered autonomous mobile vehicle 10), the energy storage 142 may already contain a non-zero charge level. In other words, the drive mechanism 150 is at least partially powered by the electric energy E1 generated by the fuel cell 130.

At the same time, the water W generated by the fuel cell 130 is transferred to the electrolyzer 160 through the pipeline P3. In an embodiment, in order to obtain a flow rate of the water W, the sensor 170 such as a water flow sensor is disposed in the pipeline P3. In another embodiment, the sensor 170 is disposed in the fuel cell 130. At this stage, as the fuel cell 130 continuously performs the first redox reaction, the water W is continuously transferred to the electrolyzer 160 for accumulation. The sensor 170 senses the flow rates of the water W transferred by the fuel cell 130 to the electrolyzer 160 at different time points and generates, based on the flow rates of the water W, a plurality of corresponding sensing signals S1 that are transmitted to the processor 146. The processor 146 receives the sensing signals S1 and sums up the measured flow rates based on the sensing signals S1 to estimate a water level value accumulated in the electrolyzer 160.

Then, when the estimated water level value exceeds the first predetermined value, the processor 146 transmits a drive signal S2 to the energy storage 142 to drive the energy storage 142 to supply electric energy E4 to the electrolyzer 160 via the power management system 140. In other words, the electrolyzer 160 is at least partially powered by the electric energy E1 generated by the fuel cell 130.

The electrolyzer 160, after being energized, begins to perform a water electrolysis reaction based on the water generated by the fuel cell 130 to generate hydrogen H2 and oxygen O2. At this point, a second stage of operation starts, the electrolyzer 160 continuously performs the water electrolysis reaction and continuously supplies the hydrogen H2 and the oxygen O2 to the fuel cell 130. The redox reaction performed by the fuel cell 130 at this stage is referred to as a "second redox reaction".

As shown in FIGS. 1 and FIG. 2, the hydrogen H2 is output from the electrolyzer 160 through the pipeline P4. The hydrogen H2 and the hydrogen H1 converge through the mixing valve 180 to form hydrogen H3. Then, the hydrogen H3 is delivered to the fuel cell 130 through the pipeline P2. In other words, unlike the first stage, the hydrogen H3 for the fuel cell 130 to perform the second redox reaction in the second stage includes the hydrogen H2 and the hydrogen H1.

At the same time, the oxygen O1 supplied by the outside air and the oxygen O2 generated by the electrolyzer 160 converge through the filtration and oxygen supply system 115 to form oxygen O3. Then, the oxygen O3 is delivered to the fuel cell 130 for the fuel cell 130 to perform the second redox reaction. Therefore, unlike the first stage, the oxygen O3 for the fuel cell 130 to perform the second redox reaction in the second stage includes the oxygen O2 and the oxygen O1. It should be noted that compared with the first stage at which the outside air is used solely as the oxygen supply source, at the second stage, the recycle of the oxygen O2 can improve the purity of the oxygen in the fuel cell 130, thus improving the reaction efficiency.

As the electrolyzer 160 continuously performs the water electrolysis reaction, the water level in the electrolyzer 160 drops. When the water level value falls below the second predetermined value, the processor 146 drives the energy storage 142 to stop supplying power to the electrolyzer 160. The second predetermined value is less than the first predetermined value. At this point, the second stage ends, the electrolyzer 160 stops the water electrolysis reaction, and the fuel cell 130 begins to perform the first redox reaction again.

After the start of the second stage, the processor 146 can estimate when the water level in the electrolyzer 160 drops below the second predetermined value based on the water level value in the electrolyzer 160 at the current time point and the flow rate of the water W measured by the sensor 170, thus obtaining a time point at which supplying power to the electrolyzer 160 is stopped. To achieve this purpose, a flow sensor or a pressure sensor can be disposed in the pipeline P4 that delivers the hydrogen H2 and the pipeline P5 that delivers the oxygen O2 to assist the processor 146 in performing estimation.

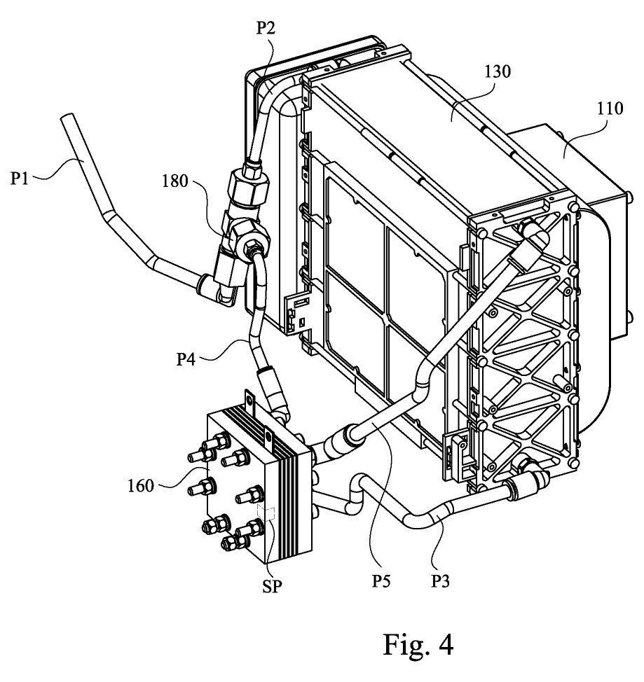

Through alternating operation between the first and second stages, the water generated by the fuel cell 130 can be recycled to improve the endurance of the hydrogen-powered autonomous mobile vehicle 10. Reference is made to FIG. 4, which is a partial perspective view of the hydrogen-powered autonomous mobile vehicle 10.

To ensure that the water generated by the fuel cell 130 can be transferred to the electrolyzer 160 through the pipeline P3, a connection position between the pipeline P3 and the fuel cell 130 is slightly higher than a connection position between the pipeline P3 and the electrolyzer 160. In an embodiment, a check valve is further disposed in the pipeline P3 to prevent the backflow of the water. In addition, the pipelines that deliver hydrogen and oxygen (e.g., the pipeline P2, the pipeline P4, and the pipeline P5) are connected to upper halves of the fuel cell 130 and the electrolyzer 160, respectively. In addition, as previously mentioned, in an embodiment, the sensor 170 may be disposed in the fuel cell 130 to obtain the water level value in the fuel cell 130. For example, the sensor 170 can be disposed at a position that is inside the fuel cell 130 and corresponding to a dashed box SP in FIG. 4.

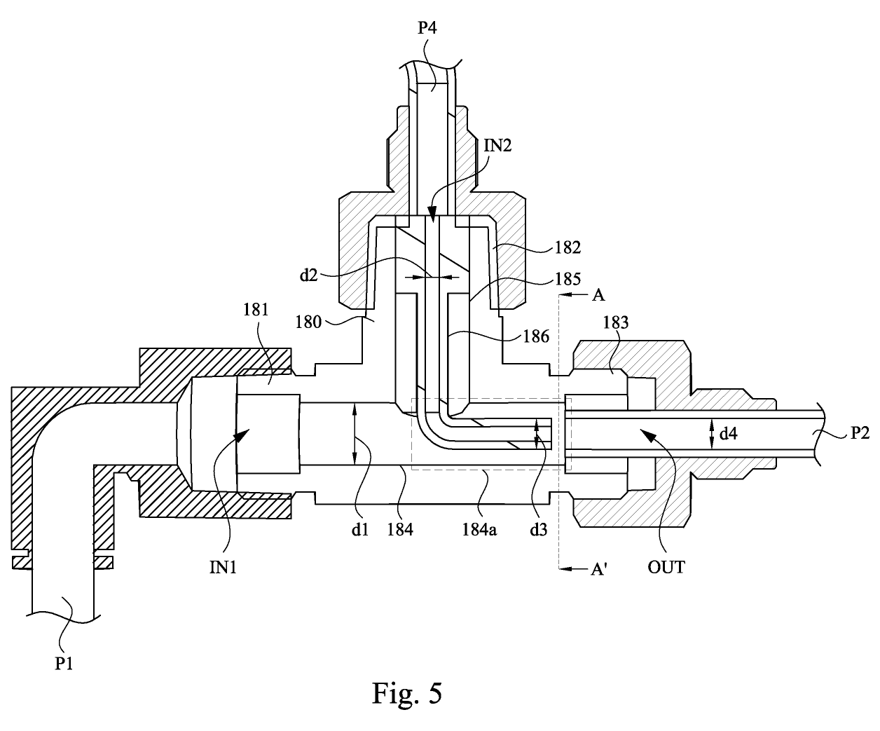

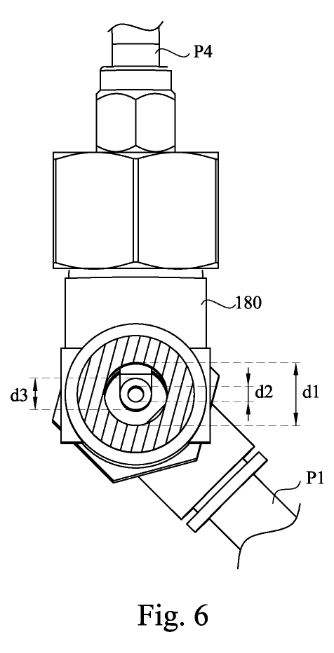

Reference is made to FIGS. 5 and FIG. 6, which are partial cross-sectional views of the hydrogen-powered autonomous mobile vehicle 10 respectively. FIG. 6 is taken along a section line A-A' in FIG. 5. The detailed structure of the mixing valve 180 of the hydrogen-powered autonomous mobile vehicle 10 and its configuration relationship with other pipelines will be described below.

As shown in FIG. 5, the mixing valve 180 has a first connector 181, a second connector 182, and a third connector 183. The first connector 181 has a first gas intake port IN1. The second connector 182 has a second gas intake port IN2. The third connector 183 has an outlet port OUT. The first gas intake port IN1 and the outlet port OUT are opposite to each other and communicated through a flow channel 184. The second gas intake port IN2 is communicated with the flow channel 184 through a flow channel 185. As shown in FIG. 5, the first connector 181 and the third connector 183 are on opposite sides of the flow channel 185. As shown in the cross-sectional view, the flow channel 184 may be perpendicular to the flow channel 185 so that the mixing valve 180 has a T-shaped profile.

In addition, the mixing valve 180 further includes a gas intake pipe 186. The gas intake pipe 186 is configured to receive the hydrogen delivered by the pipeline P4. As shown in FIG. 5, the gas intake pipe 186 is coupled to the second connector 182 and extends from the second gas intake port IN2 through the flow channel 185 into the flow channel 184. One end of the gas intake pipe 186 extends towards the second gas intake port IN2 and the pipeline P4, and the other end extends towards the outlet port OUT and the pipeline P2. The gas intake pipe 186 may have an L-shaped profile, but the disclosure is not limited thereto. The gas intake pipe 186 has an inner diameter d2, and a portion of the gas intake pipe 186 in the flow channel 184 has an outer diameter d3.

Reference is made to FIGS. 2, FIG. 4, and FIG. 5. The pipeline P1 for output of the hydrogen supplied by the hydrogen storage device 120 is communicated with the first gas intake port IN1 through the first connector 181, so that the hydrogen storage device 120 is coupled to the first gas intake port IN1 of the mixing valve 180. The pipeline P4 for recycle of the hydrogen generated by the electrolyzer 160 is communicated with the second gas intake port IN2 and the gas intake pipe 186 through the second connector 182, so that the electrolyzer 160 is coupled to the gas intake pipe 186 of the mixing valve 180. The pipeline P2 for input of the converged hydrogen into the fuel cell 130 is communicated with the outlet port OUT through the third connector183, so that the fuel cell 130 is coupled to the outlet port OUT of the mixing valve 180. The pipeline P2 can partially extend to the inside of the third connector 183.

The hydrogen generated by the electrolyzer 160 has a lower pressure and is less stable than the hydrogen stored at high pressure in the hydrogen storage device 120. Therefore, in order to avoid the backflow of the hydrogen when the fuel cell 130 and/or the electrolyzer 160 stop performing the reactions, the mixing valve 180 is disposed such that the inner diameter d2 of the gas intake pipe 186 is less than the inner diameter d1 of the flow channel 184, as shown in FIGS. 5 and FIG. 6. As such, when the fuel cell 130 and/or the electrolyzer 160 stop performing the reactions, a gas pressure of the first gas intake port IN1 is less than a gas pressure of the gas intake pipe 186, thereby preventing high-pressure hydrogen in the hydrogen storage device 120 from flowing into the gas intake pipe 186 through the pipeline P1.

Meanwhile, the inner diameter d2 of the gas intake pipe 186 is less than an inner diameter d4 of the pipeline P2. Therefore, a gas pressure of the gas intake pipe 186 is greater than a gas pressure of the pipeline P2. In this way, depending on a difference in pressure gradient, the hydrogen from the electrolyzer 160 flows into the pipeline P2 through the gas intake pipe 186. A zone 184a of the flow channel 184 close to the pipeline P2 is occupied by the gas intake pipe 186, so a portion of the zone 184a that allows the hydrogen to flow through has a smaller cross-sectional area (e.g., a cross-sectional area of the portion of the zone 184a equals a circular area of the inner diameter d1 of the flow channel 184 minus a circular area of the outer diameter d3 of the gas intake pipe 186) than a cross-sectional area of other zones of the flow channel 184. As a result, the hydrogen from the hydrogen storage device 120 can flow into the pipeline P2. The pressure of the hydrogen from the electrolyzer 160 in the gas intake pipe 186 is greater than the pressure of the hydrogen from the hydrogen storage device 120 in the zone 184a, so that the hydrogen from the hydrogen storage device 120 do not flow into the electrolyzer 160. Then, both the hydrogen from the electrolyzer 160 and the hydrogen from the hydrogen storage device 120 flow into the pipeline P2 to facilitate the uniform mixing of the converged hydrogen.

According to the foregoing recitations of the embodiments of the disclosure, it may be seen that in the hydrogen-powered autonomous mobile vehicle and the operating method of the same according to an embodiment of the disclosure, by disposing an electrolyzer, water generated by a redox reaction performed by a fuel cell can be directly collected and subjected to a water electrolysis reaction. Then, hydrogen and oxygen generated by the water electrolysis reaction are directly supplied to the fuel cell for a further redox reaction. To be more specific, hydrogen and oxygen for the fuel cell to perform the redox reaction can be supplied from multiple sources to extend the power supply duration, improve the endurance of the hydrogen-powered autonomous mobile vehicle, and improve the transportation efficiency for automated warehousing.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure covers modifications and variations of this disclosure provided they fall within the scope of the following claims.

What is claimed is:

1. A hydrogen-powered autonomous mobile vehicle, comprising:
a carrier;
a mixing valve on the carrier and having a first gas intake port, a second gas intake port, and an outlet port, wherein the first gas intake port and the outlet port are opposite to each other and communicated through a first flow channel, and the second gas intake port is communicated with the first flow channel through a second flow channel, the mixing valve further comprising a gas intake pipe extending from the second gas intake port through the second flow channel to the first flow channel;
a hydrogen storage device on the carrier and coupled to the first gas intake port of the mixing valve;
a fuel cell on the carrier and configured to perform a first redox reaction based on hydrogen supplied by the hydrogen storage device to generate electric energy and water, wherein the fuel cell is coupled to the outlet port of the mixing valve;
an energy storage on the carrier and configured to receive the electric energy generated by the fuel cell; and
an electrolyzer on the carrier and configured to receive the water generated by the fuel cell and perform a water electrolysis reaction to generate hydrogen and oxygen, wherein the electrolyzer is powered by the energy storage, and the electrolyzer is coupled to the gas intake pipe of the mixing valve,
wherein the mixing valve is configured such that the hydrogen supplied by the hydrogen storage device and the hydrogen generated by the water electrolysis reaction converge and are delivered to the fuel cell, and the fuel cell is configured to further perform a second redox reaction based on the converged hydrogen.

2. The hydrogen-powered autonomous mobile vehicle of claim 1, further comprising a processor communicatively connected to the energy storage, wherein the processor is configured to drive the energy storage to supply power to the electrolyzer to perform the water electrolysis reaction when an accumulation of the water received by the electrolyzer from the fuel cell exceeds a predetermined value.

3. The hydrogen-powered autonomous mobile vehicle of claim 2, further comprising a water flow sensor coupled between the fuel cell and the electrolyzer and communicatively connected to the processor, wherein the water flow sensor is configured to sense a flow rate of the water received by the electrolyzer from the fuel cell and to transmit a sensing signal to the processor.

4. The hydrogen-powered autonomous mobile vehicle of claim 1, wherein an inner diameter of the gas intake pipe is less than an inner diameter of the first flow channel.

5. The hydrogen-powered autonomous mobile vehicle of claim 1, wherein the fuel cell is coupled to the electrolyzer, and the fuel cell is configured to receive the oxygen generated by the water electrolysis reaction.

6. The hydrogen-powered autonomous mobile vehicle of claim 1, further comprising a drive mechanism on the carrier and configured to drive the carrier to move, wherein the drive mechanism is powered by the energy storage.

7. The hydrogen-powered autonomous mobile vehicle of claim 1, further comprising a gas intake device on the carrier and configured to deliver an outside air to the fuel cell, wherein oxygen for the first redox reaction is provided by the outside air.

8. The hydrogen-powered autonomous mobile vehicle of claim 1, wherein the second flow channel is perpendicular to the first flow channel so that the mixing valve has a T-shaped profile.

9. The hydrogen-powered autonomous mobile vehicle of claim 1, wherein the mixing valve further comprises a first connector, a second connector, and a third connector, wherein the first gas intake port is at the first connector, the second gas intake port is at the second connector, the outlet port is at the third connector, the gas intake pipe is coupled to the second connector and has an L-shaped profile, one end of the gas intake pipe extends to the second gas intake port, and the other end of the gas intake pipe extends to the outlet port.

10. An operating method of a hydrogen-powered autonomous mobile vehicle, comprising:
performing, by a fuel cell, a first redox reaction based on hydrogen and oxygen to generate electric energy and water;
transferring the water generated by the fuel cell to an electrolyzer;
performing, by the electrolyzer, a water electrolysis reaction based on the water generated by the fuel cell to generate hydrogen and oxygen, wherein the electrolyzer is at least partially powered by the electric energy generated by the fuel cell;
after the water electrolysis reaction, allowing the hydrogen generated by the electrolyzer and hydrogen supplied by a hydrogen storage device to converge by a mixing valve, wherein the mixing valve has a first gas intake port, a second gas intake port, and an outlet port, wherein the first gas intake port and the outlet port are opposite to each other and communicated through a first flow channel, and the second gas intake port is communicated with the first flow channel through a second flow channel, the mixing valve further comprises a gas intake pipe that extends from the second gas intake port through the second flow channel to the first flow channel such that a pressure of the hydrogen generated by the electrolyzer and flowing in the gas intake pipe is greater than a pressure of the hydrogen supplied by the hydrogen storage device and flowing in the first flow channel; and
further performing, by the fuel cell, a second redox reaction based on the converged hydrogen.

11. The operating method of the hydrogen-powered autonomous mobile vehicle of claim 10, wherein the first redox reaction is performed based on the hydrogen supplied by the hydrogen storage device and oxygen from an outside air, wherein the outside air is delivered to the fuel cell by a gas intake device.

12. The operating method of the hydrogen-powered autonomous mobile vehicle of claim 11, wherein the hydrogen generated by the electrolyzer flows through the gas intake pipe of the mixing valve, the hydrogen supplied by the hydrogen storage device flows through the first flow channel of the mixing valve, and an inner diameter of the gas intake pipe is less than an inner diameter of the first flow channel.

13. The operating method of the hydrogen-powered autonomous mobile vehicle of claim 10, further comprising delivering the oxygen generated by the electrolyzer to the fuel cell after the water electrolysis reaction such that the fuel cell performs the second redox reaction.

14. The operating method of the hydrogen-powered autonomous mobile vehicle of claim 10, further comprising storing the electric energy generated by the fuel cell in an energy storage, wherein the energy storage is electrically connected to the electrolyzer and configured to supply power to the electrolyzer.

15. The operating method of the hydrogen-powered autonomous mobile vehicle of claim 14, further comprising supplying, by the energy storage, power to a drive mechanism for a carrier to drive the carrier to move, wherein the fuel cell, the electrolyzer, the energy storage, and the drive mechanism are on the carrier.

16. The operating method of the hydrogen-powered autonomous mobile vehicle of claim 10, further comprising:
obtaining, by a sensor, a water level value in the electrolyzer; and
when the water level value exceeds a first predetermined value, supplying power to the electrolyzer so that the electrolyzer begins to perform the water electrolysis reaction.

17. The operating method of the hydrogen-powered autonomous mobile vehicle of claim 16, wherein the sensor is a water flow sensor coupled between the fuel cell and the electrolyzer.

18. The operating method of the hydrogen-powered autonomous mobile vehicle of claim 17, wherein the obtaining, by the sensor, the water level value in the electrolyzer comprises:
sensing, by the sensor, a plurality of flow rates of the water transferred by the fuel cell to the electrolyzer at a plurality of time points, and generating a plurality of sensing signals; and
receiving, by a processor, the sensing signals, and obtaining the water level value in the electrolyzer based on the plurality of sensing signals, wherein the processor is communicatively connected to the sensor.

19. The operating method of the hydrogen-powered autonomous mobile vehicle of claim 18, wherein the processor is further communicatively connected to an energy storage and is configured to drive the energy storage to supply power to the electrolyzer.

20. The operating method of the hydrogen-powered autonomous mobile vehicle of claim 16, further comprising stopping supplying power to the electrolyzer when the water level value in the electrolyzer is less than a second predetermined value, wherein the second predetermined value is less than the first predetermined value.
